(19) United States
(12) Patent Application Publication
(10) Pub. No.: US 2017/0175534 A1
(43) Pub. Date: Jun. 22, 2017

(54) BLADE ASSEMBLY ON BASIS OF A MODULAR STRUCTURE FOR A TURBOMACHINE

(71) Applicant: General Electric Technology GmbH, Baden (CH)

(72) Inventors: Joergen FERBER, Wutöschingen (DE); Simone HOEVEL, Lengnau (CH); Thomas OPDERBECKE, Untersiggenthal (CH); Dmitry YAKUSHKOV, Moscow (RU); Alexey DROZDOV, Velikie Luki (RU)

(73) Assignee: General Electric Technology GmbH, Baden (CH)

(21) Appl. No.: 15/039,277

(22) PCT Filed: Nov. 24, 2014
(86) PCT No.: PCT/EP2014/075422

§ 371 Date: May 25, 2016

(30) Foreign Application Priority Data
Nov. 25, 2013 (EP) 13194259.1

(51) Int. Cl. F01D 5/14; F01D 5/28; F01D 5/18; F02C 3/04; F01D 15/10

(52) U.S. Cl. CPC F01D 5/147; F02C 3/04; F01D 15/10; F01D 5/187; F01D 5/186; F01D 5/288; F05D 2220/32; F05D 2230/60; F05D 2300/10; F05D 2300/20

(57) ABSTRACT

A blade assembly having a modular structure, wherein the blade elements include at least a rotor blade airfoil, a footboard mounting part and a heat shield. The elements each have at its one ending an interchangeable connection for connection among each other, wherein the connection of the airfoil with respect to the other elements is based on a fixation in radial or quasi-radial extension compared to the rotor axis of the turbomachine. The assembling of the blade airfoil in connection with the footboard mounting part is based on a force-fit or form-fit fixation, or on use of a metallic and/or ceramic surface for the purpose of a friction-locked bonding actuated by adherence interconnecting, or on friction-locking with a detachable, permanent or semi-permanent fixation.

### TECHNICAL FIELD

The present invention relates to a blade assembly for a turbomachine, preferably a gas turbine engine, and basically refers to a modular rotor blade with one or more removable elements or modules. The term blade is to define in a broad sense and includes also stator vanes, heat shields, etc.

Basically, the modular blade assembly comprises various interchangeable modules or elements, wherein the mentioned parts are substitutable or non-substitutable.

A blade assembly on the basis of a modular structure is provided and includes a blade airfoil which extends in a blade longitudinal direction and at the lower end merges, optionally, into an inner platform or other intermediate embodiments and, subsequently, terminating in a customary blade root with preferentially a fir-tree-shaped cross-sectional profile by which the blade can be fastened on a blade carrier, in case of a rotor blade on a rotor disk, wherein the blade airfoil and/or the inner platform or other intermediate embodiments having at its one end means for the purpose of an interchangeable connection of the blade elements, wherein the connection of the blade elements among each other having a permanent or semi-permanent fixation of the blade airfoil in radially or quasi-radially extension with respect to the axis of the turbomachine, wherein the assembling of the blade airfoil in connection with the inner platform or directly with the blade root is based on a friction-locked bonding actuated by adherence interconnecting, or the assembling of the blade airfoil in connection with the inner platform or directly with the blade root based on the use of a metallic and/or ceramic surface the fixing rotor blade elements to each other, or the assembling of the blade airfoil in connection with the inner platform or directly with the blade root based on force closure means with a detachable or permanent connection, wherein at least the blade airfoil comprises at least one outer hot gas path liner encasing at least one part of the blade airfoil of the rotor blade.

Cooling passages extend inside the blade airfoil for cooling the rotor blade and are supplied with a cooling medium, particularly cooling air, via a feed hole which is arranged on the shank at the side or directly via the blade root.

The detachable or permanent connection comprises a force closure with bolt or rivet or is made by HT brazing, active brazing, soldering. Additionally, the inner platform and/or the blade root can be made of one piece or of a composite structure.

Furthermore, the inner platform and/or the blade root comprises means and/or inserts which are able to resist thermal and physical stresses, wherein the mentioned means are holistically or on their part interchangeable among one another.

### BACKGROUND OF THE INVENTION

US 2011/268582 A1 discloses a blade, comprising a blade airfoil which extends in the longitudinal direction of the blade along a longitudinal axis. The blade airfoil, which is delimited by a leading edge and a trailing edge in the flow direction, merges into a shank at the lower end beneath a platform which forms the inner wall of the hot gas passage, the shank terminating in a customary blade root with a fir-tree-shaped cross-sectional profile by which the blade can be fastened on a blade carrier, especially on a rotor disk, by inserting into a corresponding axial slot (see, for example, FIG. 1 of U.S. Pat. No. 4,940,388).

It is notorious and state of the art that rotor blades are equipped with cooling passages which extend inside the blade airfoil for cooling the blade and are supplied with a cooling medium, particularly cooling air.

Referring to said US document, the cooling passages extend inside the blade airfoil for cooling the blade and are supplied with a cooling medium, particularly cooling air, via a feed hole which is arranged on the shank at the side. The shank, similar to the blade airfoil, has a concave and a convex side. The feed hole, which extends obliquely upwards into the interior of the blade airfoil, opens into the outside space on the convex side of the shank. In order to reduce the mechanical stresses which are associated with the mouth of the feed hole and at the same time to positively influence the vibration behavior of the blade, provision is made around the mouth of the feed hole for a planar stiffening element which reaches beyond the direct vicinity of the feed hole, which stiffening is formed integrally on the shank and consists of the same material as the blade. As is to be seen from the cross section of the stiffening element in FIG. 3, the stiffening element is formed as a large-area plateau, and-from the opening of the feed hole arranged to the left of the center plane reaches far beyond the center plane of the blade so that the stiffening element is formed symmetrically to the center plane and also encompasses the mouth of the feed hole.

In US 2013/0089431 A1 a blade airfoil for a turbine system is disclosed. The blade airfoil includes a first body having exterior surfaces defining a first portion of an aerodynamic contour of the blade airfoil and formed from a first material. The blade airfoil further includes a second body having exterior surfaces defining a second portion of an aerodynamic contour of the blade airfoil, the second body coupled to the first body and formed from a second material having a different temperature capability than the first material. In another embodiment, a nozzle for a turbine section of a turbine system is disclosed. The nozzle includes a blade airfoil having exterior surfaces defining an aerodynamic contour, the aerodynamic contour comprising a pressure side and a suction side extending between a leading edge and a trailing edge. The blade airfoil includes a first body having exterior surfaces defining a first portion of the aerodynamic contour of the blade airfoil and formed from a first material. The blade airfoil further includes a second body having exterior surfaces defining a second portion of the aerodynamic contour of the blade airfoil, the second body coupled to the first body and formed from a second material having a different temperature capability than the first material. The accompanying drawings of this US document, especially FIGS. 3 through 6, together with description, illustrate embodiments and serve to explain the principles of this state of the art.

U.S. Pat. No. 5,700,131 shows an internally cooled turbine blade for a gas turbine engine that is modified at the leading and trailing edges to include a dynamic cool air flowing radial passageway with an inlet at the root and a discharge at the tip feeding a plurality of radially spaced film cooling holes in the blade airfoil surface. Replenishment holes communicating with the serpentine passages radially spaced in the inner wall of the radial passage replenish the cooling air lost to the film cooling holes. The discharge orifice is sized to match the backflow margin to achieve a constant film-hole coverage throughout the radial length. Trip strips may be employed to augment the pressure drop distribution. Also well known by those skilled in this technology is that the engine's efficiency increases as the pressure ratio of the turbine increases and the weight of the turbine decreases. Needless to say, these parameters have limitations. Increasing the speed of the turbine also increases the blade airfoil loading and, of course, satisfactory operation of the turbine is to stay within given blade airfoil loadings. The blade airfoil loadings are governed by the cross sectional area of the turbine multiplied by the velocity of the tip of the turbine squared, or AN<2>. Obviously, the rotational speed of the turbine has a significant impact on the loadings. The spar/shell construction contemplated by this invention affords the turbine engine designer the option of reducing the amount of cooling air that is required in any given engine design. And in addition, allowing the designer to fabricate the shell from exotic high temperature materials that heretofore could not be cast or forged to define the surface profile of the blade airfoil section. In other words, by virtue of this invention, the shell can be made from Niobium or Molybdenum or their alloys, where the shape is formed by a well-known electric discharge process (EDM) or wire EDM process. In addition, because of the efficacious cooling scheme of this invention, the shell portion could be made from ceramics, or more conventional materials and still present an advantage to the designer because a lesser amount of cooling air would be required.

EP 2 642 076 shows a connecting system for metal components and CMC components, a turbine blade retaining system and rotating component retaining system are provided. The connecting system includes a retaining pin, a metal foam bushing, a first aperture disposed in the metal component, and a second aperture disposed in the ceramic matrix composite component. The first aperture and the second aperture are configured to form a through-hole when the metal component and the ceramic matrix composite component are engaged. The retaining pin and the metal foam bushing are operably arranged within the through-hole to connect the metal component and the ceramic matrix composite component.

U.S. Pat. No. 8,162,617 B1 relates to a turbine blade with a spar and shell construction in which the spar and the shell are both secured within two platform halves. The spar and the shell each include outwards extending ledges on the bottom ends that fit within grooves formed on the inner sides of the platform halves to secure the spar and the shell against radial movement when the two platform halves are joined. The shell is also secured to the spar by hooks extending from the shell that slide into grooves formed on the outer surface of the spar. The hooks form a serpentine flow cooling passage between the shell and the spar. The spar includes cooling holes on the lower end in the leading edge region to discharge cooling air supplied through the platform root and into the leading edge cooling channel. The spar 11 includes elbow shaped slots 21 that extend along the outer surface of the spar 11 from the top to the bottom, as shown in FIG. 1 and FIG. 5. The slots 21 are shaped and positioned to receive the hooks 22 extending from the shell 12 and secure the shell 12 to the spar 11 and minimize the flexing apart between the spar and shell. The wording “ . . . minimize the flexing apart between the spar and shell” does not mean, that the hooks and the slots form a force-fit connection.

Additionally, shrinking joint or shrink-fitting is a technique in which an interference fit is achieved by a relative size change after assembly. This is usually achieved by heating or cooling one component before assembly and allowing it to return to the ambient temperature after assembly, employing the phenomenon of thermal expansion to make a joint. For example, the thermal expansion of a piece of a metallic drainpipe allows a builder to fit the cooler piece to it. As the adjoined pieces reach the same temperature, the joint becomes strained and stronger.

The turbine blade according to U.S. Pat. No. 3,810,711 includes a hollow strut covered with a porous laminated material to provide a cooled blade portion and includes a supporting strut portion terminating in one or two bases for attachment to a turbine wheel. It also includes a blade platform bi-cast to the strut at the junction of the blade and supporting portions. The strut may be fabricated by casting or forging two parts, each defining one face of the strut, bonding these together at the leading edge of the airfoil, machining the leading edge portion, fitting the facing to the blade portion of the strut and bonding these together, then forming the blade portion to the desired airfoil contour and thereafter bi-casting the platform onto the strut so as to cover the platform end of the blade facing.

### SUMMARY OF THE INVENTION

The present invention has for its object to provide a structure or architecture of a blade of a turbomachine built from a plurality of interchangeable modules or elements optimized to the various operation regimes of the turbomachine, particularly a gas turbine. In a separate process the various modules or elements may be repaired and/or reconditioned.

In accordance with the claims it is proposed:

The structure of the blade includes substantially a blade airfoil, an inner platform, a fir-tree-shaped cross-sectional profile by which the blade can be fastened on a blade carrier, e.g. a rotor disk, as main modules with additional sub-modules, especially an intermediate shank between the inner platform and the footboard mounting part, also called root, having preferably a fir-tree-shaped cross-sectional profile. As an additional sub-module of the blade airfoil the tip comprises a heat shield with seal means.

Accordingly, the inventive idea of the present invention leaves the use of typical blade structures, basically consisting of a blade airfoil, an inner platform and a footboard mounting part made in one piece as depicted and explained in connection with the state of the art.

Especially, by using a blade which can be assembled from at least two separate parts, i.e. a separate blade airfoil and a separate inner platform, preconditions are created to provide interchangeability or repairing and/or reconditioning of the identified separate parts, modules, elements without replacing the whole rotor blade.

It is also possible to parcel out rotor blades basically in four separate parts, i.e. heat shield, blade airfoil, inner platform and footboard mounting part. If the blade comprises an intermediate shank between inner platform and footboard mounting part the same implementation of this basic idea can be applied.

Usually, the inner platform is an integral part of the blade. Due to that, during operation at elevated temperatures thermal stress is induced into the transition part from the blade airfoil to the inner platform of the rotor blade. This means that at the leading and trailing edges of the blade airfoil stress concentrations result which may lead to local failure of the material or at least increase the reconditioning effort.

Named stress concentration and local failure of the material can be avoided by decoupling the inner platform from the blade airfoil portion. In addition with decoupling these portions also different degration mechanism can be separated, like oxidation of the inner platform from the low cycle fatigue of the blade airfoil portion. By decoupling from each other, both have to carry themselves in corresponding carrier. The same proceeding can be adopted with respect to the heat shield.

In case of a fixed position of the rotor blade, by at least the fixing means at the inner end of the blade airfoil, the blade airfoil of the rotor blade stays in close contact or is connected in one piece with the inner platform which boarders the hot gas flow through the turbine stage towards the inner diameter of the hot gas flow channel of the turbine stage. On the other hand the inner platform which is connected with the blade airfoil in a flush manner or which is manufactured in one piece with the blade airfoil borders the hot gas flow channel radially outwards.

The blade assembly of a turbomachine on the basis of a modular structure comprises a heat shield, a blade airfoil, an inner platform and a footboard mounting part. The blade airfoil and/or the inner platform and/or the heat shield and/or the footboard mounting part have at its one end means for the purpose of an interchangeable connection of the mentioned modules, wherein the used connection of the rotor blade modules to each other has a permanent or semi-permanent fixation of the blade airfoil in radial or quasi-radial extension with respect to the rotor axis of the turbomachine. The assembling of the blade airfoil in connection with the other modules is based on a directly or indirectly friction-locked bonding actuated by adherence interconnecting.

Alternatively, the assembling of the airfoil in connection with the mentioned interdependent modules is based on the use of a metallic and/or ceramic surface fixing the modules to each other. Alternatively, the assembling of the blade airfoil in connection with the other modules is based on force closure means with a detachable or permanent connection, wherein at least the blade airfoil comprises at least one outer hot gas path liner encasing at least one part of the blade airfoil.

The outer hot gas path liner, also called outer shell, represents the aero profile and is an interchangeable module with variants in cooling and/or material configurations and/or corporal compounding adapted to the different operating regimes of the gas turbine engine respectively of a power plant.

Accordingly, the rotor blade comprises a blade airfoil having at its one end radially or quasi-radially directed means for inserting into a recess and/or boost of an inner platform for the purpose of a detachable or semi-detachable or permanent or quasipermanent connection resp. fixation of the blade airfoil.

This fixation can be made by means of a friction-lock, actuated by adherence or through the use of a metallic and/or ceramic surface coating, or by a force closure with bolt or rivet, or by HT brazing, active brazing or soldering.

The same proceeding is also applied to the blade airfoil with respect to the heat shield, wherein the inner and outer modules can be made of one piece or of a composite structure.

According to individual operative requirements or individual operating regimes of the turbomachine, the footboard mounting part, the inner platform, the blade airfoil, the heat shield comprising additional means and/or inserts, which are able to resist thermal and physical stress, wherein the mentioned means and inserts are holistically or on their part interchangeable.

However, it must be ensured that the inner platform and the heat shield of the rotor blade of the first row are aligned adjacent to each other in circumferential direction limiting an annular hot gas flow in the area of the entrance opening of the turbine stage.

In case of a detachable fixation between the inner end of the blade airfoil and the inner platform, as mentioned before in connection with a preferred embodiment, the inner platform provides at least one recess for insertion the hook like extension or lug of the blade airfoil at its radially inwards directed end so that the blade airfoil is fixed at least in axial and circumferential direction of the turbine stage.

The hook like extension has a cross like cross section which is adapted to a groove inside the inner platform. The recess inside the inner platform provides at least one position for insertion or removal at which the recess provides an opening through which the hook like extension of the blade airfoil can be inserted completely only by radial movement. The shape of the extension of the blade airfoil and the recess in the inner platform is preferably adapted to each other like a spring nut connection.

For insertion or removal purpose it is possible to handle the blade airfoil only at its radially outwards directed end which is a remarkable feature for performing maintenance work at the turbine stage.

The term “radial” as used herein, refers to the rotor axis of the turbomachine and the installed blade in its operational position.

It is feasible that the inner platform is detachably mounted to an intermediated piece, for example to a shank, or directly to the footboard mounting part which is also detachably mounted to the inner structure respectively inner component of the turbine stage. Hereto the intermediate piece provides at least one recess for insertion a hook like extension of the inner platform for axial, radial and circumferential fixation of the inner platform.

Basically, the intermediate piece allows some movement of the inner platform in axial, circumferential and radial direction. There are some axial, circumferential and radial stops in the intermediate piece to prevent the inner platform from unrestrained movements. With the axial and circumferential stop the blade airfoil of the rotor blade is not cantilevered but supported at the outer and inner platform. An additional spring type feature presses the inner platform against a radial stop within the intermediate piece, so that the blade airfoil can be mounted into the outer and inner platform by sliding the blade airfoil radially inwards from a space above the heat shield liner.

Furthermore, a possible kind of attaching the blade airfoil and outer shell or outer shell portions to the inner platform respectively heat shield consists of receiving the radial end of the blade airfoil in a recess provided in the heat shield. Likewise, the radial end of the blade airfoil can be received in a recess provided in the inner platform. The mentioned recesses can be substantially blade airfoil-shaped so as to correspond to the outer contour of the blade airfoil or blade airfoil assembly. Thus, the blade airfoil and blade airfoil assembly including outer shell arrangement can be trapped between the inner platform and the heat shield.

Moreover, existing solutions according to the mentioned state of the art under section “Background of the Invention” cover only parts of the object of the present invention. One of the most important aspects of the invention is to provide at least one outer and, if necessary and according to individual operative requirements or different operating regimes, at least one intermediate shell that is not exposed to the e.g. hot gas flow of a gas turbine. The function of the blade airfoil carrier is to carry the mechanical load of the blade airfoil module. In order to protect the blade airfoil carrier with respect to the high temperature and separate thermal deformation of the blade airfoil module, an outer and, additionally, an intermediate shell can be applied.

Accordingly, the intermediate shell is in any case optional. It may be required as compensator for potentially different thermal expansion of outer shell and spar and/or cooling shirt for additional protection of the spar. The outer shell is joined to the optional intermediate shell or spar generally by interference fit, and the intermediate shell is also joined to the spar by interference fit.

The spar, including the tip cap, is manufactured by additive manufacturing methods and includes a cooling configuration which in addition to cool the spar itself may feed the outer shell and the optional intermediate shell with cooling media.

Furthermore, the intermediate shell provides additional protection to the spar in case of damage of the outer shell. Basically, the intermediate shell is an interchangeable module with variants in cooling and/or material configurations adapted to the different operating regimes of the turbomachine.

If several superimposed shells are provided, they can be built with or without spaces between them.

The mentioned shells can be made of at least two segments. Preferably, the components, forming the shell, are connected together so as to permit assembly and disassembly of the shell, shell components, blade airfoil and various components of the blade.

In principle, the complete shell includes a leading edge and a trailing edge in conformity with the structure and the aero profile of the blade airfoil.

The advantages achieved by the invention, especially referring to an outer shell, particularly consist in the fact that it is possible to use standardized components and in a particularly simple way to produce blades that are individually and specifically matched to locally varying conditions of use resp. adapted to the different operating regimes of the gas turbine engine respectively of the power plant.

Even with a blade airfoil that is of standardized design, by suitably selecting geometry and positioning of the flow-applied element in relation to the blade airfoil, it is possible to compensate or reduce local differences in flow impact onto the individual blades. As a result the flow impact in a particular blade row becomes aerodynamically more homogenous. It is in this way possible, inter alia, to reduce the excitation of oscillations in the rotor blade region. Such use of adding flow-applied parts to adapt the blade airfoil of a standard rotor blade to different conditions of use can in particular replace the production and holding in stock of different, geometrically similar components, namely a large number of complete blades that are individually adapted to the particular conditions of use of the turbomachine.

In the event of damage to the flow-charged outer shell, repair involves the replacement of only the damaged subcomponents as opposed to the entire blade airfoil. The modular design facilitates the use of various materials in the shell, including materials that are dissimilar. Thus, suitable materials can be selected within the shell components to optimize component life, cooling air usage, aerodynamic performance, and cost.

The flow-charged shell assembly can further include a seal provided between a recess and at least one of the radial ending of the shell and the outer peripheral surface of the blade airfoil close to its radial end. As a result, hot gas infiltration or cooling air leakage, except when an effusion cooling is provided, can be excluded, if the shell segments can be brazed or welded along their radial interface at or near the outer peripheral surface so as to close the gaps. Alternatively, the gaps can be filled with a compliant insert or other seal (rope seal, tongue and groove seal, sliding dovetail, etc.) to prevent hot gas ingress and migration through the gaps. In all cases, the interchangeability of the single shell or shell components is to be maintained.

The gap or groove of the radial interface of the single shell components can be filled with a ceramic rope, and/or a cement mixture can be used. An alternative consists in a shrinking shell or shrinking shell components on the blade airfoil. If in such a case the interchangeability of the shell or shell components is not guaranteed, it must be ensured that the entire blade airfoil arrangement can be replaced.

Both, the inner platform and the heat shield can be formed similar to the blade airfoil.

Especially the mentioned inner platform can be made of at least two segments. Preferably, the components forming the inner platform are connected together or to the blade airfoil and/or shell components so as to permit assembly and disassembly of this inner platform.

The loaded side of platforms is equipped with one or more fixed or removable inserts. The insert equipment forms an integral coverage or capping with respect to the e.g. hot gas loaded area.

The mentioned insert equipment has a coating surface, which is able to resist thermal and physical stresses, wherein the mentioned equipment comprises inserts that are holistically or on their part interchangeable.

The gap or groove of the axial and or radial interface of the single inserts within the outer and inner platform can be filled with a ceramic rope, and/or a cement mixture can be used. An alternative consists in shrinking capping components onto the mentioned platforms. If in such a case the interchangeability of the inserts is not guaranteed, it must be ensured that the entire platform can be replaced.

Regardless of the specific manner in which the blade airfoil or shells are attached to the inner platform and heat shield, the hot gases in the turbine must be prevented from infiltrating into any spaces between the recesses in the mentioned elements and blade airfoil resp. blade airfoil shells, so as to prevent undesired heat inputs and to minimize flow losses.

If the blade airfoil is internally cooled with a cooling medium at a higher pressure than the hot combustion gases, excessive cooling medium leakage into the hot gas path can occur. To minimize such concerns, one or more additional seals can be provided in connection with the shell arrangement. The seals can be at least one of rope seals, W-shaped seals, C-shaped seals, E-shaped seals, a flat plate, and labyrinth seals. The seals can be made of various materials including, for example, metals and ceramics.

Additionally, a thermal insulating material or a thermal barrier coating (TBC) can be applied to various portions of the rotor blade assembly.

The main advantages and features of the present invention are as follows:
Thermo-mechanical decoupling of modules improves part lifetime compared to integral design.
Modules with different variants in cooling and/or material configuration can be selected to best fit to the different operating regimes of the turbomachine.
It is possible to introduce an inner spar which extends from the root of the blade to the tip of the blade airfoil and can be secured to the attachment at the root by various connection means.
The blade airfoil comprises a single outer shell or additional intermediate shell components which can be selected in a manner to optimize component life, cooling usage, aerodynamic performance, and to increase the capability of resistance against high temperature stresses and thermal deformation.
The shells are segmented in various arrangements, wherein the individual part can be made of appropriate materials.
The capping or introduction of various inserts in connection with the inner platform and heat shield can be selected in a manner to optimize component life, cooling usage, aerodynamic performance, and to increase the capability of resistance against high temperature stresses and thermal deformations.
Root, inner platform, blade airfoil, heat shield and additional integrated elements can be coated with a selected thermal insulating material or a thermal barrier coating.
The spar having various passageways to supply a cooling medium through the blade.
The cooling of all above mentioned elements/modules of the blade mainly consists of a convective cooling, with selected impingement and/or effusion cooling sections.
The interchangeability of all elements/modules to each other is given as a matter of principle.
The fixation of the various elements/modules to one another can be made by means of a friction-locked actuated by adherence or through the use of a metallic and/or ceramic surface coating, or by a force closure with bolt or rivet, or by HT brazing, active brazing or soldering.
The platforms may be composed of individual parts, on the one hand being actively connected to the blade airfoil and shell elements and on the other hand being actively connected to rotor and stator.
The modular design of the blade airfoil facilitates the use of various materials in the shell, including materials that are dissimilar, in accordance with the different operating regimes of the turbomachine.
The modular blade assembly consists of replaceable and non-replaceable elements.
The blade airfoil has a pronounced or swirled aerodynamic profile in radial direction, is cast, machined or forged comprising additionally additive features with internal local web structure for cooling or stiffness improvements. Furthermore, the blade airfoil may be coated and comprise flexible cooling configurations for adjustment to operation requirements, such as base-load, peak-mode, partial load of the turbomachine.
The inner platform is cast, forged or manufactured in metal sheet or plate. The inner platform is consumable and replaced in predetermined cycles and may additionally be mechanically decoupled from the blade airfoil, wherein the inner platform may be mechanically connected to the airfoil carrier using force closure elements, namely bolts. The inner platform may be coated with CMC or ceramic materials.
The shank is cast, forged or manufactured in metal sheet or plate. The shank is normally not consumable, and may be mechanically decoupled from the blade airfoil, wherein the shank may additionally be mechanically connected to the airfoil using force closure elements, namely bolts. The inner platform may be coated with CMC or ceramic materials.
If the blade airfoil is provided with an outer platform on the side of stator, this element is cast, forged or manufactured in metal sheet or plate. The outer platform is consumable in relation of predetermined cycles and replaced frequently as specified maintenance period and may be mechanically decoupled from the blade airfoil, wherein the outer platform may additionally be mechanically connected to rotor blade airfoil using force closure elements, namely bolts. The outer platform may be coated with CMC or ceramic materials.
The spar as sub-structure of the flow-charged blade airfoil or the shell assembly is interchangeable, pre-fabricated, single or multi-piece, uncooled or cooled, using a convective and/or film and/or effusion and/or impingement cooling structure.
The outer shell and additional intermediate shells are interchangeable, consumable, pre-fabricated, single or multi-piece with radial or circumferential patches and using a shrinking joint to the sub-structure.

The foregoing and other features of the present invention will become more apparent from the following description and accompanying figures.

### BRIEF DESCRIPTION OF THE FIGURES

The invention shall subsequently be explained in more detail based on exemplary embodiments in conjunction with the drawing. In the drawing:

FIG. 1 shows an exemplary rotor blade for a gas turbine;

FIG. 2 shows a longitudinal section through the rotor blade;

FIG. 3 shows a further longitudinal section through the rotor blade;

FIG. 4 shows a partial longitudinal section through the upper end of the rotor blade airfoil;

FIG. 5 shows a partial longitudinal section through the root of the rotor blade;

FIG. 6 shows a cross section through the rotor blade airfoil;

FIG. 7 shows a platform with inserts or mechanical interlocks optionally sealed by HT ceramics;

FIG. 8 shows a joining technology in the range of the tip of the rotor blade airfoil;

FIG. 9 shows a further joining technology in the range of the tip of the rotor blade airfoil;

FIG. 10 a, b, c shows a rotor blade which is composed of various elements and materials at different views;

FIG. 11 a, b shows a longitudinal section through the rotor blade airfoil at different views;

FIG. 12 shows a root portion with a fir-tree-shaped profile.

### DETAILED DESCRIPTION OF EXEMPLARY EMBODIMENTS

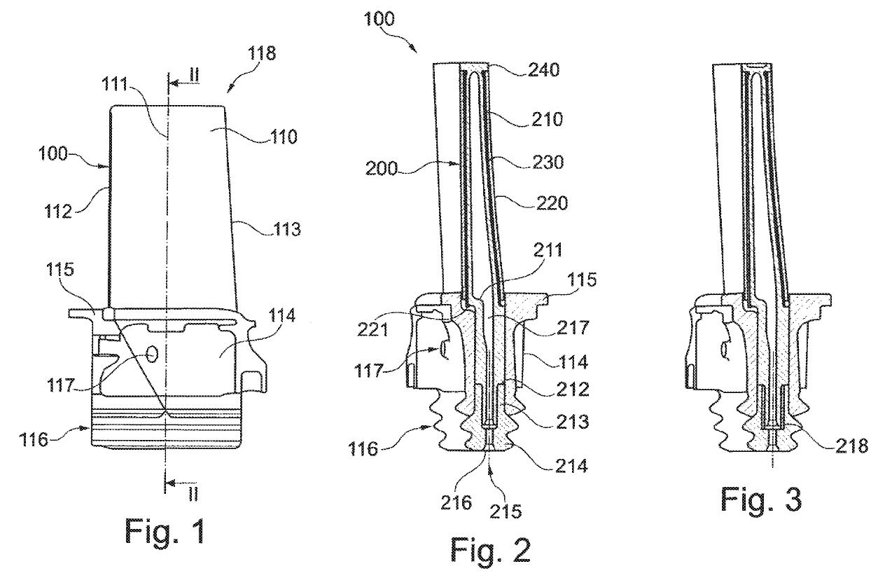

In FIG. 1 a rotor blade 100 according to an exemplary embodiment of the invention is reproduced. The rotor blade 100 comprises a blade airfoil 110 which extends in the longitudinal direction of the rotor blade along a longitudinal axis 111. The blade airfoil 110, which is delimited by a leading edge 112 and a trailing edge 113 in the flow direction, merges into a shank 114 at the lower end beneath an inner platform 115 which forms the inner wall of the hot gas passage, the shank is terminating in a customary blade root 116 with a fir tree profile by which the blade 100 can be fastened on a blade carrier, especially on a rotor disk, by inserting it into a corresponding axial slot.

The inner platform abuts the platforms of neighboring blades and defines a gas passage inner wall for the turbine. A row of outer not shown heat shields at the tip of the blade airfoil 118 defines the outer wall of the hot gas path of the gas turbine.

Cooling passages, which are not shown, extend inside the blade airfoil 110 for cooling the rotor blade 100 and are supplied with a cooling medium, particularly cooling air, via a feed hole 117 which is arranged on the shank 114 at the side (see FIG. 2). The shank 114, similar to the blade airfoil 110, has a concave and a convex side. In FIG. 1 the convex side faces the viewer. The feed hole 117, which extends obliquely upwards into the interior of the blade airfoil 110, opens into the outside space on the convex side of the shank 114.

FIG. 2 shows a section taken from sectional lines II-II of FIG. 1. The airfoil of the rotor blade 100, generally illustrated as reference numeral 200, comprises an outer shell assembly 220, 230 and a generally elliptically shaped spar 210. The spar 210 extending longitudinally or in the radial direction from a root portion 116 to a tip 240 with a downwardly extending first portion 211 and a second portion 212 that fair into a rectangular shaped projection 213 that is adapted to fit into an attachment 214 which is anchored in a final complementary portion 214 with the same outer contour compared to the fir-tree-shaped cross-sectional profile 116.

The shank 114 may be formed with the inner platform 115 or the platform 115 may be formed separately and joined thereto and projects in a circumferential direction to abut against the inner platform in the adjacent rotor blade in the turbine disk (not shown). A seal (not shown) may be mounted between platforms of adjacent rotor blades to minimize or eliminate leakage around the individual rotor blades.

The tip 118 of the rotor blade 100 may be formed integrally with the spar 210 or may be a separate piece that is suitably joined to the top end of the spar 210. The outer shell 220 extends over the surface of the spar 210 and ends in the central portion 221 spaced from the outer surface of the spar 210.

The outer shell 220 defines a pressure side, a suction side, a leading edge 112 and a trailing edge 113 (see FIG. 1). As mentioned above, the outer shell 220 may be made from different materials depending on the different operating regimes of the gas turbine engine. The outer shell 220 can be made in a single unit or consist of various parts, divided along the longitudinal axis 111 (see FIG. 1), similar to the spar 210.

As shown in FIG. 2, the cooling air 215 is additionally (see numeral 117) admitted through an inlet 216, the central opening formed at the ingress in the final complementary portion 214 and, subsequently, in the spar 210, and flows in a straight passage or interior cavity 217 in radial or quasi-radial direction.

According to FIG. 2 an intermediate shell 230 may be introduced. The intermediate shell 230 constitutes one of the important features of the invention. It may be required as compensator for potentially different thermal expansion of outer shell 220 and spar 210 and/or cooling shirt for additional protection of the spar. The outer shell 220 is joined to the intermediate shell 230 or generally to the spar 210 by interference fit, wherein the intermediate shell 230 is also joined to the spar by interference fit.

Furthermore, the intermediate shell 230 provides additional protection to the spar 210 in case of damage of the outer shell 220. Basically, the intermediate shell 230 is an interchangeable module with variants in cooling and/or material configurations adapted to the different operating regimes of the gas turbine engine. If several superimposed shells are provided, they may be built with or without spaces between each other.

The internal cooling of the shells may be individually provided, or the cooling being operatively connected with the inner cooling of the blade airfoil.

FIG. 3 shows a further section taken from sectional lines II-II of FIG. 1. The distinguishing feature with respect to FIG. 2 is that an additional retaining sleeve 218 is introduced in the rectangular shaped projection 213.

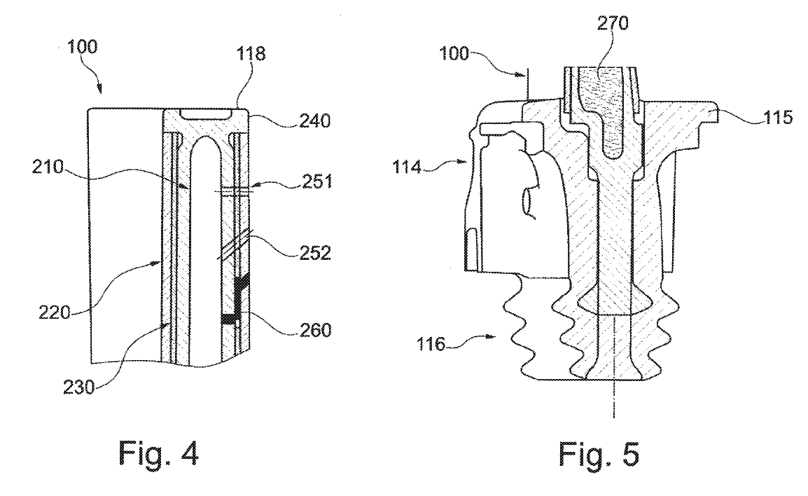

FIG. 4 shows a partial longitudinal section through the upper end of the blade airfoil. The tip 118 of the rotor blade 100 may be sealed by a 240 that may be formed integrally with the spar 210, or may be a separate piece that is suitably joined to the top end of the spar 210. The outer shell 220 extends over the surface of the spar 210. According to FIG. 4 an intermediate shell 230 may be introduced. The intermediate shell 230 constitutes one of the important features of the invention. It may be required as compensator for potentially different thermal expansion of outer shell 220 and spar 210 and/or cooling shirt for additional protection of the spar. The outer shell 220 is joined to the intermediate shell 230 or generally to the spar 210 by interference fit, wherein the intermediate shell 230 is also joined to the spar by interference fit. Additionally, FIG. 4 shows different configurations of cooling holes 251, 252 through the elements of the rotor blade airfoil in partial or integral manner. Furthermore, FIG. 4 shows a feeding cavity 260 in the intermediate shell 230. The spar 210 and the various shells 220, 230 are provided in the flow and peripheral directions with a number of regularly or irregularly distributed cooling holes 251, 252 having the most varied cross-sections and directions compared to the flow direction of the cooling medium. Through the cooling holes a cooling medium quantity flows outside of the rotor blade, and an increase in the velocity is induced along the surface of the rotor blade.

FIG. 5 shows a partial longitudinal section through the root of the rotor blade. The interior cavity of the rotor blade airfoil (see FIG. 2, item 217) is integrally or partially filled with an appropriate material 270 which can exert various functions.

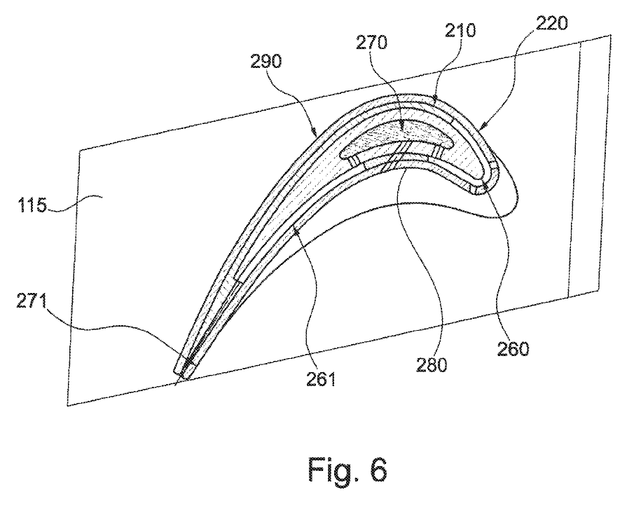

FIG. 6 shows a cross section through the rotor blade airfoil, comprising an inner platform 115, a pressure side 280, a suction side 290, an outer shell 220, a spar 210, a filling material 270 (see FIG. 5), feeding cavities 260, 261, a rib 271 situated in the region of the trailing edge of the rotor blade airfoil.

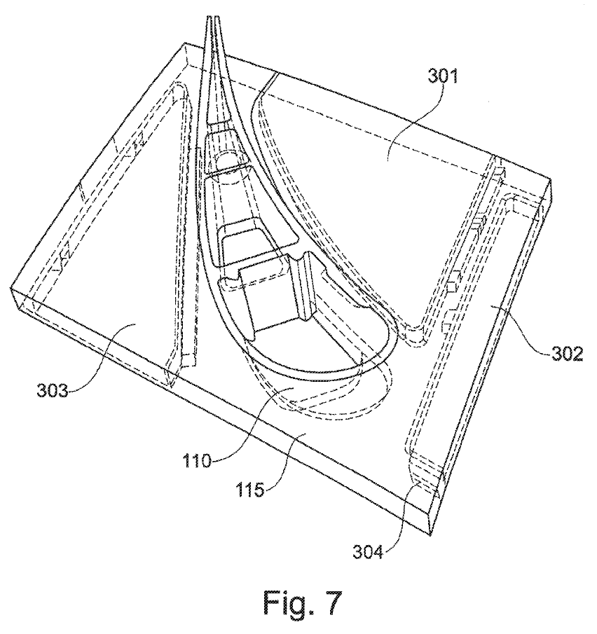

FIG. 7 shows a platform 115 of a rotor blade assembly with inserts and/or mechanical interlocks 301-303 optionally sealed by HT ceramics. This arrangement may involve an inner and/or outer platform, and/or airfoil, and/or outer hot gas path liner, and be disposed along or within the thermal stress areas, namely the flow-charged zone of the rotor blade. The insert element and/or mechanical interlock forming the respective flow-charged zone are inserted at least in a force-fitting manner into appropriately designed recesses or in the manner of a push loading drawer with additional fixing means 304. Additionally, the insert element and/or mechanical interlock may be sealed by HT ceramics.

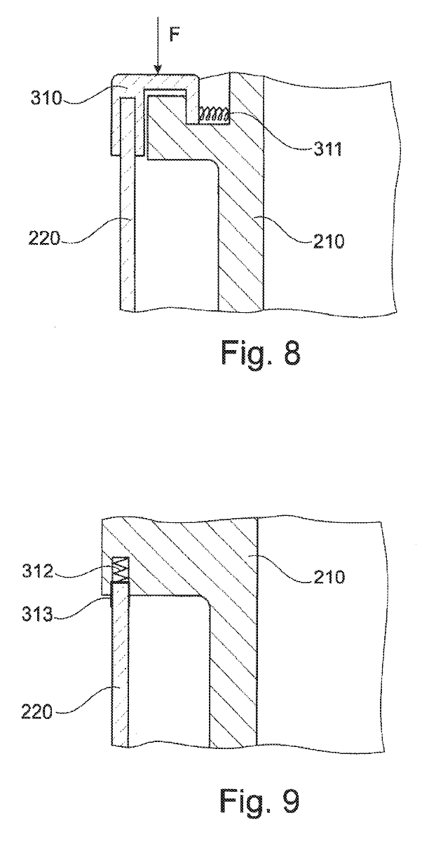

FIG. 8 shows a joining technology in the range of the tip of the rotor blade airfoil. Specifically, FIG. 8 shows the connection between the spar 210 and the outer shell 220. The mentioned elements 210, 220 are assembled with the aid of a force F acting metallic clamp 310 in axial direction. A spring 311 results actively connected to the metallic clamp 310 and the spar 210, and indirectly to the outer shell 220.

FIG. 9 shows a further joining technology in the range of the tip of the rotor blade. The assembly in connection with the outer shell 401 with respect to the spar 600 comprises a spring 312 and a metallic cover element 313.

Important aspects of the shown joining in connection with FIGS. 8 and 9 are as follows: CMC or metallic outer shell is necessary to protect the sensitive metallic spar. To avoid point mechanical load, especially on the CMC, reduces the risk of failure. The CMC or metallic outer shell may be fixed by brazing, soldering or using HT ceramic adhesives. The concept involves an interference fit with ceramic bush an compensator (spring) and fixation of CMC or metallic shell with metallic clamp and spring (FIG. 8) or by spring and metallic cover (FIG. 9).

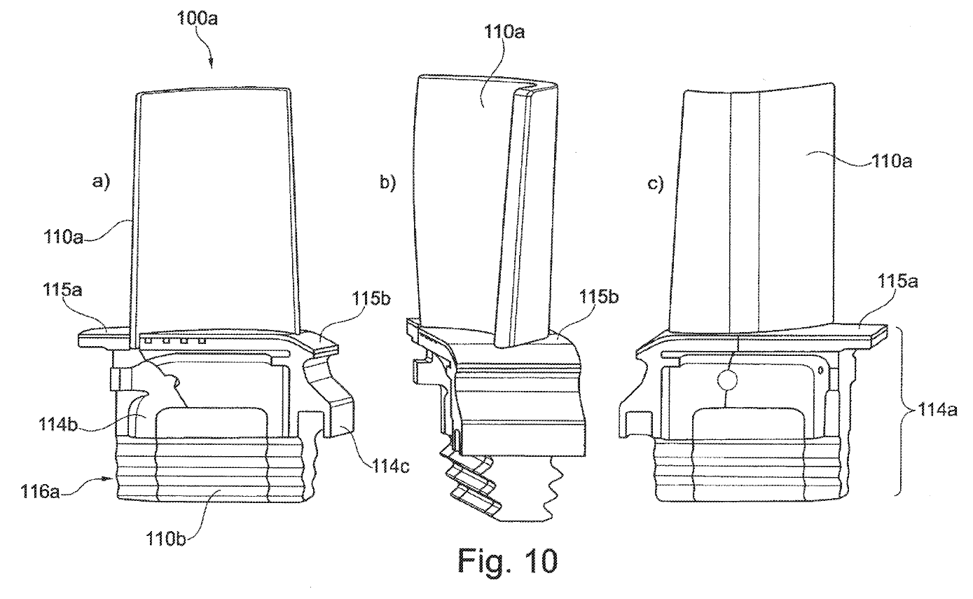

FIG. 10 a-c shows a further rotor blade 100a according to an exemplary embodiment of the invention. The rotor blade 100a comprises a blade airfoil 110a which extends in the longitudinal direction of the rotor blade along a longitudinal axis of the airfoil (see FIG. 1). The blade airfoil 110a, which is delimited by a leading edge and a trailing edge in the flow direction (see FIG. 1), merges into a shank 114a at the lower end beneath an inner platform 115a and 115b which forms the inner wall of the hot gas passage. The shank 114a consists of two parts 114b and 114c which can be assembled from the side and which clamp the elongation 110b of the airfoil 110a. Accordingly, the blade root 116a is composed of three parts 114b, 114c, 110b, which, assembled together, form a coherent fir-tree-shaped profile

The flow-charged surfaces of the individual parts 115a and 115b of the inner platform possess either a special thermal coating, or they are fitted with inserts which act against the thermal stress.

Additionally, the configuration of the blades, as shown in Figures c-d, is evident to a person skilled in the art.

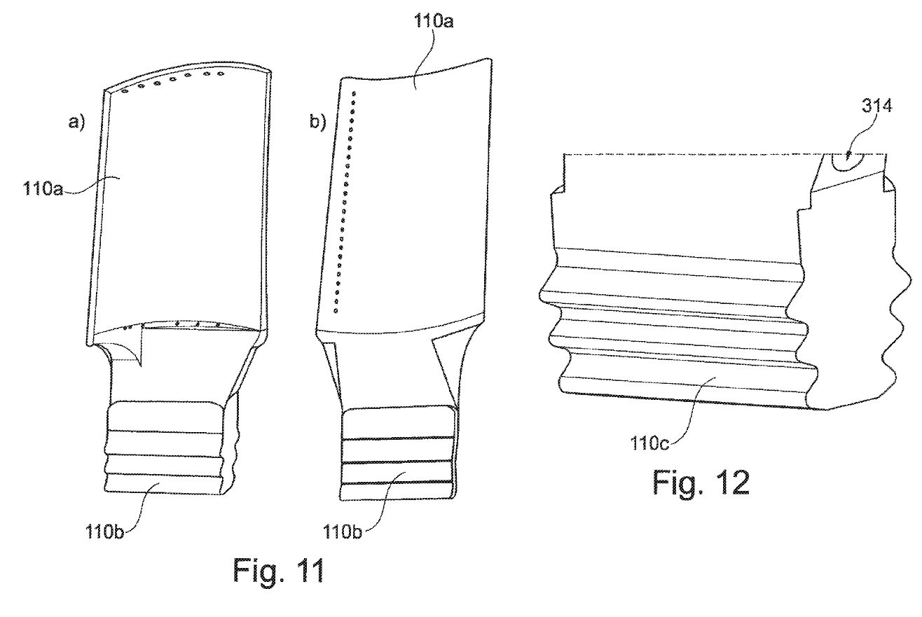

FIG. 11 a, b shows an airfoil 110a having a pressure side and a suction side and a sub-structure, consisting—in radial direction of the airfoil—of an elongated and relatively slim formed portion 110b. The elongated portion 110b extends over the entire height of the footboard mounting part. The essential part of the elongated portion 110b consists of a fir tree profile, which is actively connected to the fir tree profile of the adjacent shank parts 114b and 114c according to FIGS. 10 a-c.

Finally, FIG. 12 shows the fir tree profile 110c, which is available as an individual part and having a groove 314 which is used to hold the upper part of the airfoil.

### LIST OF REFERENCES NUMEROUS

100 Rotor blade
100a A further rotor blade
110 Rotor blade airfoil
110a Rotor blade airfoil
110b Fir-tree-shaped profile
111 Longitudinal axis
112 Leading edge of the blade airfoil
113 Trailing edge of the blade airfoil
114 Shank
114a Composable shank
114b Shank part
114c Shank part
115 Inner platform
115a Inner platform part
115b Inner platform part
116 Blade root, root portion
116a Fir-tree-shaped root portion
117 Feed hole
118 Tip of the blade airfoil
200 Embodiments of the rotor blade
210 Spar
211 Downwardly extending first portion
212 Downwardly extending second portion
213 Rectangular shaped portion
214 Final complementary portion
215 Cooling air or cooling medium
216 Inlet
217 Interior cavity
218 Retaining sleeve
220 Outer shell
221 Central portion
230 Intermediate shell
240 Tip
251 Cooling holes
252 Cooling holes
260 Feeding cavity
261 Feeding cavity
262 Feeding cavity
270 Filling material
271 Rib
280 Pressure side
290 Suction side
301 Insert, mechanical interlock
302 Insert, mechanical interlock
303 Insert, mechanical interlock
305 Fixing means
310 Metallic clamp
311 Spring
312 Spring
313 Cover element
314 Groove

1. A blade assembly for a turbomachine based on a modular structure, comprising: blade elements having at least a blade airfoil, a footboard mounting part and a heat shield, wherein the blade elements each have one ending means for interchangeable connection among each other, wherein the connection of the airfoil with respect to other blade elements is based on a fixation in radial or quasi-radial extension compared to a rotor axis of a turbomachine, wherein assembling of the blade airfoil in connection with the footboard mounting part and/or other elements is based on a force-fit or form-fit fixation, or the assembling of the blade airfoil in connection with the footboard mounting part and/or other elements is based on use of a metallic and/or ceramic surface for a friction-locked bonding actuated by adherence interconnecting, or the assembling of the blade airfoil in connection with the footboard mounting part and/or other elements is based on friction-locked means with a detachable, permanent or semi-permanent fixation, wherein at least the blade airfoil includes at least one flow-charged outer hot gas path liner which encases at least one part of a basic blade airfoil or basic sub-structure of the blade airfoil.

2. A blade assembly for a turbomachine based on a modular structure, comprising: blade elements having at least a blade airfoil and a footboard mounting part, wherein the blade elements each have one ending means for interchangeable connection among each other, wherein the connection of the airfoil with respect to other blade elements is based on a fixation in radial or quasi-radial extension compared to a rotor axis of a turbomachine, wherein assembling of the blade airfoil in connection with the footboard mounting part is based on a force-fit or form-fit fixation, or the assembling of the blade airfoil in connection with the footboard mounting part to each other is based on use of a metallic and/or ceramic surface for a friction-locked bonding actuated by adherence interconnecting, or the assembling of the blade airfoil in connection with the footboard mounting part is based on friction-locked means with a detachable, permanent or semipermanent fixation, wherein at least the blade airfoil includes at least one flow-charged outer hot gas path liner which encases at least one part of a basic blade airfoil or basic sub-structure of the blade airfoil, wherein the flowcharged outer hot gas path liner is connected with respect to the basic blade airfoil or another basic sub-structure of the airfoil using a shrinking joint.

3. A blade assembly for a turbomachine based on a modular structure, comprising: blade elements having at least a blade airfoil, a footboard mounting part and a shank, wherein the blade elements each have one ending means for interchangeable connection among each other, wherein the connection of the airfoil with respect to other blade elements is based on a fixation in radial or quasi-radial extension compared to a rotor axis of a turbomachine, wherein assembling of the blade airfoil in connection with other elements is based on a force-fit or form-fit fixation, or the assembling of the blade airfoil in connection with other elements is based reciprocally on use of a metallic and/or ceramic surface for friction-locked bonding actuated by adherence interconnecting, or the assembling of the blade airfoil in connection with other elements is based on friction-locked means with a detachable, permanent or semi-permanent fixation, wherein at least a basic blade airfoil includes at least one flow-applied outer hot gas path liner which integrally encases the outer contour of the blade airfoil or basic sub-structure of the blade airfoil, complying with aerodynamic aspects of the rotor blade, wherein the outer hot gas path liner includes at least two bodies forming the outer contour of the blade airfoil, wherein these bodies have radial or quasi-radial gaps, which are filled with a seal and/or a ceramic material.

4. The blade assembly according to claim 1, wherein the rotor blade airfoil has a pronounced or swirled aerodynamic profile in radial direction.

5. The blade assembly according to claim 1, wherein the basic sub-structure of the blade airfoil includes a spar which extends from the footboard mounting part of the rotor blade to a tip of the blade airfoil.

6. The blade assembly according to claim 1, in combination with a turbomachine which is a gas turbine with a hot gas path and wherein the flowcharged outer hot gas path liner partially encases an outer contour of the blade airfoil in a flow direction of the hot working medium of the gas turbine, complying with aerodynamic aspects of the blade.

7. The blade assembly according to claim 1 wherein a first flow-charged outer hot gas liner has on the inside a second non flowcharged or partially flow-charged outer hot gas liner, complying with aerodynamic aspects of a rotor blade.

8. The blade assembly according to claim 1, wherein at least the first flow-charged outer hot gas path liner integrally encases the outer contour of the blade airfoil, complying with aerodynamic aspects of the rotor blade, wherein the first outer hot gas path liner comprises at least two bodies forming completely or partially the outer contour of the blade airfoil.

9. The blade assembly according to claim 8, wherein the bodies, completely or partially forming the outer hot gas path liner, are brazed or welded along their radial interface.

10. The blade assembly according to claim 1, wherein the means for interchangeable connection of the blade elements have reciprocal lugs or recesses based on a friction-locked bonding or permanent connection.

11. The blade assembly according to claim 1, wherein an inner platform and/or heat shield of the footboard mounting part comprises at least one insert element and/or additional thermal barrier coating along thermal stress areas.

12. The blade assembly according to claim 1, wherein an inner platform and/or heat shield of the footboard mounting part comprises at least one insert element and/or mechanical interlock on the thermal stress areas, wherein the insert and/or mechanical interlock complies with aerodynamic aspects of the rotor blade.

13. The blade assembly according to claim 1, wherein at least one insert element and/or mechanical interlock are inserted at least in a force-fitting manner into appropriately configured recesses in a space of or within an element of the rotor blade, as a push loading drawer, including additional fixing means, wherein the upper surface of the insert element and/or mechanical interlock forming the respective flow-charged thermal zone.

14. The blade assembly according to claim 13, wherein the insert element or mechanical interlock and/or the additional thermal barrier coating are disposed along thermal stress areas.

15. The blade assembly according to claim 1, wherein an internal cooling path of the blade airfoil is actively connected to a cooling structure of a first flow-charged outer gas liner, a second flow-charged outer hot gas liner and/or inner platform and/or heat shield.

16. The blade assembly according to claim 15, wherein the cooling structure comprises a convective and/or film and/or effusion and/or impingement cooling procedure.

17. The blade assembly according to claim 1, characterized in that an interior cavity of the rotor blade airfoil or spar is integrally or partially filled with a selected material.

18. The blade assembly according to claim 1, wherein assembly of an outer shell in the area of a tip of the rotor blade airfoil comprises at least one compensator for collecting thermal dilations.

19. The blade assembly according to claim 1, in combination with a turbomachine which is a part of a power plant, at least including a compressor, a combustor, a gas turbine and an electric generator.

20. A method of assembling a blade of a turbomachine which is based on a modular structure according to claim 1, wherein the blade assembly based on a modular structure includes at least a blade airfoil, a footboard mounting part and a heat shield, wherein blade elements each have one ending means interchangeable connection among each other, wherein the connection of the airfoil with respect to other blade elements is based on a fixation in radial or quasi-radial extension compared to a rotor axis of a turbomachine, wherein the method comprises: assembling of the blade airfoil in connection with the footboard mounting part and/or other elements based on a force-fit or form-fit fixation, or assembling of the blade airfoil in connection with the footboard mounting part and/or other elements based on use of a metallic and/or ceramic surface a friction-locked bonding actuated by adherence interconnecting, or assembling of the blade airfoil in connection with the footboard mounting part and/or other elements based on friction-locked means with a detachable, permanent or semi-permanent fixation, wherein at least the blade airfoil includes at least one flow-applied outer hot gas path liner which encases at least one part of a basic blade airfoil or basic sub-structure of the blade airfoil.
